(19) United States
(12) Patent Application Publication
(10) Pub. No.: US 2019/0163434 A1
(43) Pub. Date: May 30, 2019

(54) TECHNOLOGIES FOR NETWORKED VIRTUAL CONTENT IN A MOBILE COMPUTING ENVIRONMENT

(71) Applicant: Marxent Labs, LLC, Kettering, OH (US)

(72) Inventors: Barry Besecker, Xenia, OH (US); Bret Besecker, Safety Harbor, FL (US); Ken Moser, Springboro, OH (US)

(73) Assignee: Marxent Labs, LLC, Kettering, OH (US)

(21) Appl. No.: 16/201,101

(22) Filed: Nov. 27, 2018

Related U.S. Application Data
(60) Provisional application No. 62/590,933, filed on Nov. 27, 2017.

(51) Int. Cl. G06F 3/14; H04L 29/06

(52) U.S. Cl. CPC G06F 3/1454; H04L 65/1069; H04L 67/38

(57) ABSTRACT

Technologies for composing a virtual content setting on a mobile computing device are disclosed. In one or more techniques, a first virtual content may be configured on the first mobile computing device. A virtual content session may be initiated on the first mobile computing device. At least a second mobile computing device may be connected to the first mobile computing device. A modification of the first virtual content may be initiated on the first mobile computing device. A second virtual content may be received from the second mobile computing device as part of the modification of the first virtual content. The first virtual content may be modified with at least the second virtual content to form a third virtual content. The third virtual content in the virtual content session may be rendered on a display of the first mobile computing device.

### CROSS-REFERENCE TO RELATED APPLICATIONS

This application claims the benefit of U.S. Provisional Patent Application No. 62/590,933, filed on Nov. 27, 2017, the contents of which being incorporated by reference herein in its entirety, for all purposes.

This application is related by subject matter to U.S. patent application Ser. No. 16/180,733, filed on Nov. 5, 2018.

### BACKGROUND

Advancements in electrical component design and fabrication have resulted in computing hardware becoming smaller and smaller, allowing them to fit in smaller, more compact form factors. In turn, those smaller computing hardware components have been integrated into mobile computing devices, including smartphones, tablets, wearables, etc. Such components include touchscreen displays, various sensors (e.g., proximity sensors, light sensors, barometers, accelerometers, magnetometers, gyroscopes, etc.), cameras, wireless communication interfaces, etc.

As a result, mobile computing devices have become seemingly ubiquitous. Additionally, technologies have emerged to leverage the components of the mobile computing devices. One such technology is virtual reality. Virtual reality manipulates the perception of a user's environment by adding information to, and/or subtracting information from, the environment through the use of a mobile computing device.

### SUMMARY

One or more techniques may include composing a virtual content in a first mobile computing device. A first virtual content may be configured on the first mobile computing device. A virtual content session may be initiated on the first mobile computing device. At least a second mobile computing device may be connected to the first mobile computing device. A modification of the first virtual content may be initiated on the first mobile computing device. A second virtual content may be received from the second mobile computing device as part of the modification of the first virtual content. The first virtual content may be modified with at least the second virtual content to form a third virtual content. The third virtual content may be rendered in the virtual content session on a display of the first mobile computing device.

In one or more techniques, the first mobile computing device may be a virtual reality computing device. A virtual reality session may be initiated on the first mobile computing device. The third virtual content may be rendered in the virtual reality session on the first mobile computing device.

In one or more techniques, the configuration of the first virtual content on the first mobile computing device may include a receipt of the first virtual content from the second mobile computing device, and/or a rendering of the first virtual content in the virtual content session on the display of the first mobile computing device.

In one or more techniques, the configuration of the first virtual content on the first mobile computing device may include a selection of at least one virtual item for addition to the first virtual content, and/or a rendering the first virtual content in the virtual content session on the display of the first mobile computing device.

In one or more techniques, the configuration of the first virtual content on the first mobile computing device may include a determination of information regarding at least one of: a fit, a location, or a compatibility of the at least one virtual item relative to the first virtual content, and/or an addition of the at least one virtual item to the first virtual content based, at least in part, in the information. The first virtual item may be a virtual object, and/or a virtual assembly.

In one or more techniques, the first virtual content may include a virtual object, and/or a virtual assembly.

In one or more techniques, the modification of the first virtual content with at least the second virtual content to form the third virtual content may be a synchronizing of the first virtual content with a virtual content of the second mobile computing device.

In one or more techniques, the third virtual content may be simultaneously rendered in a virtual content session on a display of the second mobile computing device.

In one or more techniques, a modification of the third virtual content may be initiated on the first mobile computing device. A fourth virtual content may be received from the second mobile computing device as part of the modification of the third virtual content. The third virtual content may be modified with at least the fourth virtual content to form a fifth virtual content. The fifth virtual content may be rendered in the virtual content session on the display of the first mobile computing device.

In one or more techniques, at least a third non-mobile computing device may be connected to the first mobile computing device. A modification of the third virtual content may be initiated on the first mobile computing device. A fourth virtual content may be received from the third non-mobile computing device as part of the modification of the third virtual content. The third virtual content may be modified with at least the fourth virtual content to form a fifth virtual content. The fifth virtual content may be rendered in the virtual content session on the display of the first mobile computing device.

In one or more techniques, the modification of the third virtual content with at least the fourth virtual content to form the fifth virtual content may be a synchronization of the third virtual content with a virtual content of the third non-mobile computing device.

In one or more techniques, the fifth virtual content may be simultaneously rendered in a virtual content session on a display of the third non-mobile computing device.

### BRIEF DESCRIPTION OF THE DRAWINGS

The devices, systems, methods, and other features, advantages and disclosures contained herein, and the manner of attaining them, will become apparent and the present disclosure will be better understood by reference to the following description of various example techniques of the present disclosure taken in conjunction with the accompanying drawings, wherein:

FIG. 1 is an example block diagram a mobile computing device according to the present disclosure;

FIG. 2 is an example block diagram of a system and devices for networked virtual content in a mobile computing environment according to the present disclosure;

FIG. 3 is an example block diagram of a system and devices for networked virtual content in a mobile computing environment according to the present disclosure;

FIG. 4 is an example flow diagram of a method for networked virtual content in a mobile computing environment that may be executed by the mobile computing devices, non-mobile computing devices, and/or systems of FIG. 1 to FIG. 3; and

FIG. 5 is an example flow diagram of a method for networked virtual content in a mobile computing environment that may be executed by the mobile computing devices, non-mobile computing devices, and/or systems of FIG. 1 to FIG. 3.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of this disclosure is thereby intended.

Present technologies limit the ability of multiple parties/devices to participate in one or more virtual content sessions and/or one or more virtual reality sessions in a mobile computing environment, which may include non-mobile computing devices. Accordingly, technologies for networked (e.g., networked synced or networked-based synchronization) virtual content and/or virtual reality in a mobile computing environment may be useful.

Virtual content may be experienced via different modalities. For example, a user may experience virtual content differently, perhaps based on the capabilities of the user's computing device. For example, virtual content such as three-dimensional (3D) graphical subject matter, and/or augmented reality (AR), etc., may be experienced in a virtual reality (VR) context/session such as with computing devices that may include VR headsets/goggles, and/or other VR computing devices. For example, virtual content (VC) such as three-dimensional (3D) graphical subject matter, and/or augmented reality (AR), etc., may be experienced in non-VR devices, such as mobile computing devices, desktop computing devices (e.g., non-mobile computing devices), cloud-based computing devices, etc.

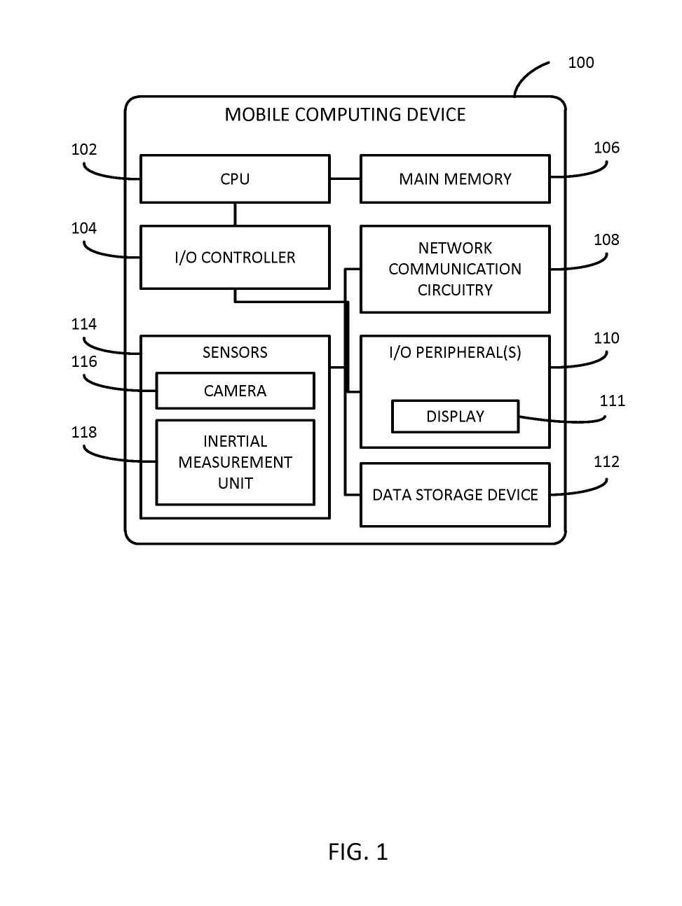

FIG. 1 shows an example block diagram of mobile computing device 100. The illustrative example of mobile computing device 100 shown in FIG. 1 includes a central processing unit (CPU) 102, an input/output (I/O) controller 104, a memory 106, a data storage device 112, and/or various sensors 114, a network communication circuitry 108 and/or one or more I/O peripherals 110. One or more mobile computing devices 100 may include additional, fewer, and/or alternative components to those of the illustrative mobile computing device 100, such as a graphics processing unit (GPU). One or more of the illustrative components may be combined on a single system-on-a-chip (SoC) on a single integrated circuit (IC). The type of components of the respective mobile computing device 100 may be predicated upon the type and/or intended use of the respective mobile computing device 100.

The CPU 102, or processor, may be embodied as any combination of hardware and/or circuitry capable of processing data. In one or more techniques, the mobile computing device 100 may include more than one CPU 102. In one or more techniques, the CPU 102 may include one processing core (not shown), such as in a single-core processor architecture, or multiple processing cores, such as in a multi-core processor architecture. Irrespective of the number of processing cores and CPUs 102, the CPU 102 may read and/or execute program instructions. For example, the CPU 102 may include cache memory (not shown) that may be integrated directly with the CPU 102 or placed on a separate chip with a separate interconnect to the CPU 102. Pipeline logic may be used to perform software and/or hardware operations (e.g., network traffic processing operations), perhaps for example rather than, or in addition to, commands issued to/from the CPU 102.

The I/O controller 104, and/or I/O interface, may be embodied as any type of computer hardware and/or combination of circuitry capable of interfacing between input/output devices and the mobile computing device 100. Illustratively, the I/O controller 104 may be configured to receive input/output requests from the CPU 102, and/or may send control signals to the respective input/output devices, thereby managing the data flow to/from the mobile computing device 100.

The memory 106 may be embodied as any type of computer hardware or combination of circuitry capable of holding data and/or instructions for processing. Such memory 106 may be referred to as main or primary memory. One or more components of the mobile computing device 100 may have direct access to memory, such that certain data may be stored via direct memory access (DMA) independently of the CPU 102.

The mobile computing device 100 may include network communication circuitry 108. The network communication circuitry 108 may be embodied as any type of computer hardware or combination of circuitry capable of managing network interfacing communications (e.g., messages, datagrams, packets, etc.) via wireless and/or wired communication modes. The network communication circuitry 108 may include a network interface controller (NIC) that may be capable of being configured to connect the mobile computing device 100 to a computer network, as well as other devices.

The one or more I/O peripherals 110 may be embodied as any auxiliary device configured to connect to and/or communicate with the mobile computing device 100. For example, the I/O peripherals 110 may include, but are not limited to, a mouse, a keyboard, a monitor, a touchscreen, a printer, a scanner, a microphone, a speaker, etc. In the example of the mobile computing device 100 shown in FIG. 1, I/O peripherals 110 may comprise display 111. The display 111 may be a touchscreen display responsive to contact from a human digit, stylus, and/or other input device. Some I/O devices may be capable of one function (e.g., input or output), or both functions (e.g., input and output).

For example, the I/O peripherals 110 may be connected to the mobile computing device 100 via a cable (e.g., a ribbon cable, a wire, a universal serial bus (USB) cable, a high-definition multimedia interface (HDMI) cable, etc.) of the mobile computing device 100. The cable may be connected to a corresponding port (not shown) of the mobile computing device 100 for which the communications made there between can be managed by the I/O controller 104. The I/O peripherals 110 may be connected to the mobile computing device 100 via a wireless mode of communication (e.g., Bluetooth®, Wi-Fi®, etc.) which can be managed by the network communication circuitry 108.

The data storage device 112 may be embodied as any type of computer hardware capable of the non-volatile storage of data (e.g., semiconductor storage media, magnetic storage media, optical storage media, etc.). Such data storage devices 112 are commonly referred to as auxiliary and/or secondary storage, which may be used to store a large amount of data relative to the memory 106 described above.

The illustrative sensors 114 may include a camera sensor 116 and/or an inertial measurement unit (IMU) sensor 118. The sensors 114 may include one or more additional sensors 114. The camera sensor may be embodied as an type of image sensor (e.g., complementary metal-oxide-semiconductor (CMOS), charge-coupled device (CCD), hybrid CCD/CMOS, etc.) capable of capturing different types of scene data, such as color image data (RGB), color and/or depth image data (RGBD camera), depth sensor, stereo camera (L/R RGB), YUV, GRAY scale, or any other image sensor technology that can generate digital image frames. The camera sensor 116 may be configured to produce digital image frames (e.g., image capture frequency) at a rate of at least 15 frames per second (fps) and/or a resolution of at least 320×240 pixels.

The IMU sensor 118 may include one or more software or hardware gyroscopes to measure the orientation of the mobile computing device 100 (e.g., a 3-axis gyroscope), accelerometers to measure proper acceleration of the mobile computing device 100 (e.g., a 3-axis accelerometer), magnetometers to measure the direction of the Earth's magnetic field relative to the mobile computing device 100 (e.g., a 3-axis magnetometer), and/or any other type of inertial motion measurement software/hardware usable to perform the functions described herein (e.g., measure motion along three perpendicular linear axes and/or the rotation around each of the three perpendicular linear axes). For example, the IMU sensor 118 may provide digital information at a sampling rate of at least 15 Hz, and/or a sampling rate equivalent to the image capture frequency and/or describes a 3-axis rotation, translation acceleration, and/or rotational acceleration, in addition to a single-axis down or gravity vector (e.g., a vector describing the direction of gravitational acceleration with respect to a local coordinate frame of the IMU sensor 118).

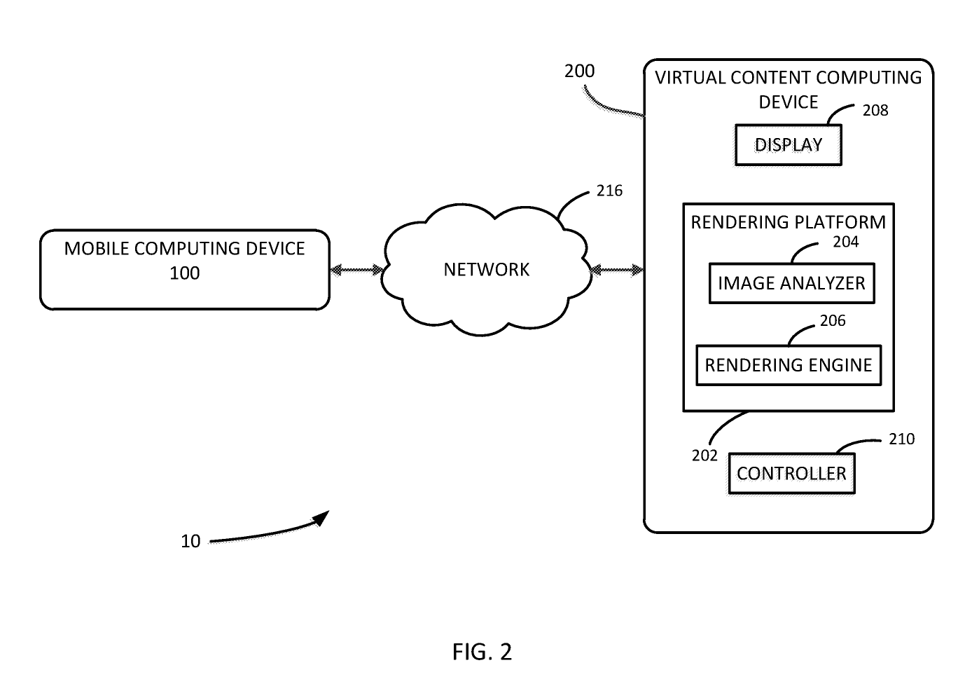

FIG. 2 shows an illustrative system 10 and devices for networked virtual content in a mobile computing environment that includes mobile computing device 100 and Virtual Content (VC) computing device 200 communicatively coupled via a network 216. In one or more techniques, VC computing device 200 and/or mobile computing device 100 may be configured to generate, process, and/or display virtual content subject matter. The VC computing device 200 may be a mobile computing device, or a non-mobile computing device.

The VC computing device 200 may be embodied as any type of compute and/or storage device comprising firmware, hardware, software, circuitry, and/or combination thereof, that may be configured to perform the functions described herein. The VC computing device 200 may contain like assets to that of the illustrative mobile computing device 100 of FIG. 1. Accordingly, such like assets are not described herein to preserve clarity of the description. While the VC computing device 200 is illustrated as a single computing device, the VC computing device 200 may include more than one computing device (e.g., in a distributed computing architecture), one or more, or each, of which may be usable to perform at least a portion of the functions described herein. The VC computing device 200 may include more than one computing device. One or more, or each, computing device of the VC computing device 200 may include one or more different assets (e.g., hardware/software resources), the types of which may be predicated upon the type and/or intended use of each computing device. For example, one or more computing devices of the VC computing device 200 may be configured as a database server with less compute capacity relative to the compute capacity of another of the computing devices of the VC computing device 200. One or more other computing devices of the VC computing device 200 may be configured as an application server with more computer capacity relative to the computer capacity of another computing device of the VC computing device 200. The VC computing device 200 may be embodied as, but is not limited to, one or more servers (e.g., stand-alone, rack-mounted, etc.), computer devices, storage devices, routers, switches, and/or combination of computer blades and/or data storage devices (e.g., of a storage area network (SAN)) in a cloud architected network and/or data center.

Virtual content (VC) computing devices may comprise rendering platform 202, controller 208, and/or display 210. Rendering platform 202 may be embodied as any combination of hardware, firmware, software, and/or circuitry usable to perform the functions described herein. The illustrative rendering platform 202 may include an image analyzer 204 and/or a rendering engine 206, one or more, or each, of which may be embodied as any type of firmware, hardware, software, circuitry, and/or combination thereof, that may configured to perform the functions described herein. The image analyzer 204 and/or the rendering engine 206 may include one or more computer-readable medium having instructions stored thereon and/or one or more processors coupled with the one or more computer-readable medium and/or configured to execute instructions to perform the functions described herein.

Display 208 may comprise a stereoscopic head mounted display comprising firmware, hardware, software, circuitry, and/or combination thereof, that may be configured to perform the functions described herein. In one or more techniques in which display 208 may comprise a stereoscopic head mounted display, display 208 may include one or more software and/or hardware gyroscopes to measure the orientation of display 208 (e.g., a 3-axis gyroscope), accelerometers to measure acceleration of display 208 (e.g., a 3-axis accelerometer), magnetometers to measure the direction of the Earth's magnetic field relative to display 208 (e.g., a 3-axis magnetometer), and/or any other type of inertial motion measurement software/hardware usable to perform the functions described herein (e.g., measure motion along three perpendicular linear axes and the rotation around each of the three perpendicular linear axes). Display 208 may comprise a mobile computing device, such as, for example, mobile computing device 100, that may be adapted for stereoscopic display of visual information. Controller 210 may be a handheld input/output device operable to transmit instructions from a user of VC computing device 200.

The network 216 may be implemented as any type of wired and/or wireless network, including a local area network (LAN), a wide area network (WAN), and/or a global network (the Internet), etc. The network 216 may include one or more communicatively coupled network computing devices (not shown) for facilitating the flow and/or processing of network communication traffic via a series of wired and/or wireless interconnects. Such network computing devices may include, but are not limited, to one or more access points, routers, switches, servers, compute devices, and/or storage devices, etc.

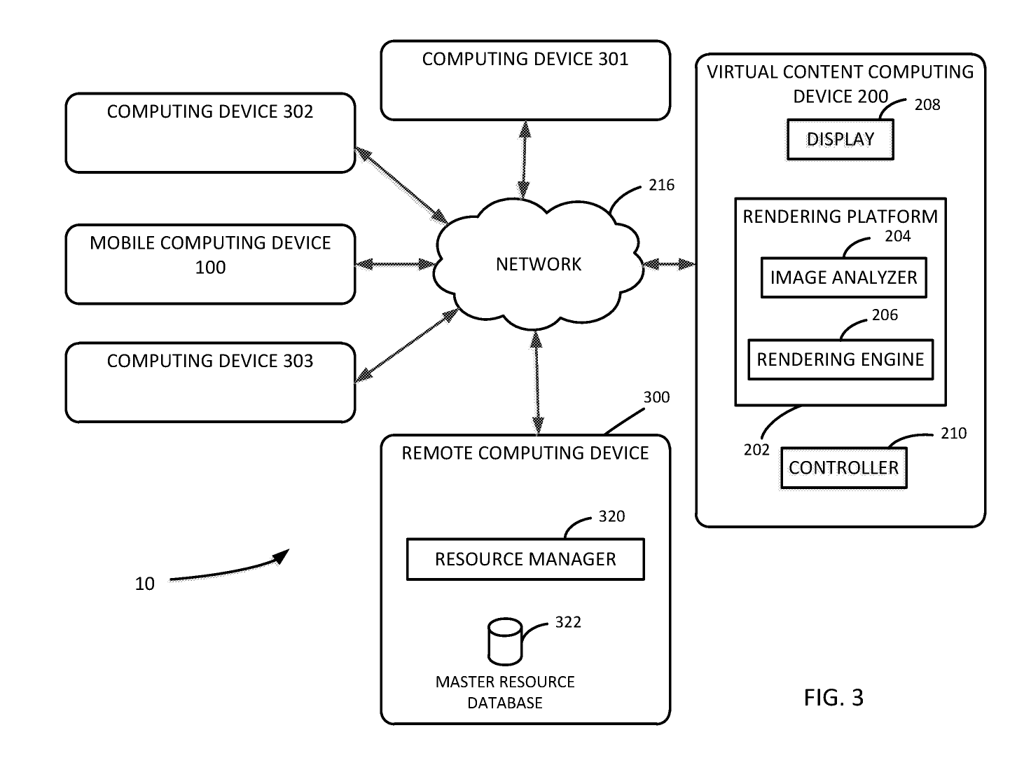

FIG. 3 shows an illustrative system 10 and devices for networked virtual content in a mobile computing environment that includes mobile computing device 100, VC computing device 200, remote computing device 300, and computing devices 301-303, one or more, or all, communicatively coupled via a network 216. In one or more techniques, VC computing device 200, mobile computing device 100, remote computing device 300, computing device 301, computing device 302, and/or computing device 303 may be configured to generate, process and/or display virtual content (VC) subject matter. Computing devices 301-303 may be mobile computing devices, and/or non-mobile computing devices.

The remote computing device 300 may be embodied as any type of compute and/or storage device comprising firmware, hardware, software, circuitry, and/or combination thereof, that may be configured to perform the functions described herein. For example, the remote computing device 300 may be embodied as, but is not limited to, one or more servers (e.g., stand-alone, rack-mounted, etc.), computer devices, storage devices, routers, switches, and/or combination of computer blades and/or data storage devices (e.g., of a storage area network (SAN)) in a cloud architected network and/or data center. While the remote computing device 300 is illustrated as a single computing device, the remote computing device 300 may include more than one computing device (e.g., in a distributed computing architecture), one or more, or each, of which may be usable to perform at least a portion of the functions described herein. The remote computing device 300 may be a mobile computing device, or a non-mobile computing device.

The remote computing device 300 may contain like assets to that of the illustrative mobile computing device 100 of FIG. 2. Accordingly, such like assets are not described herein to preserve clarity of the description. The remote computing device 300 may include more than one computing device. One or more, or each, computing device of the remote computing device 300 may include different assets (e.g., hardware/software resources), the types of which may be predicated upon the type and/or intended use of one or more, or each, computing device. For example, one or more computing devices of the remote computing device 300 may be configured as a database server with less computer capacity relative to the computer capacity of another of the computing devices of the remote computing device 300. One or more other computing devices of the remote computing device 300 may be configured as an application server with more computer capacity relative to the computer capacity of another computing device of the remote computing device 300.

Remote computing device 300 may comprise resource manager 320 and/or master resource database 322. Resource manager 320, which may be embodied as any type of firmware, hardware, software, circuitry, and/or combination thereof, may be configured to manage 3D models stored in the master resource database 322. For example, the resource manager 320 may be configured to receive a request from mobile computing device 100 and/or VC computing device 200 that may include identifying information of objects that are to be rendered as 3D models in a virtual content setting (e.g., perhaps to be viewed/experienced in a VR session/environment). Perhaps for example, upon receiving the request, among other scenarios, the resource manager 320 may be configured to retrieve the 3D models from the local resource database 322 and/or transmit them to mobile computing device 100 and/or VC computing device 200 via network 216.

Computing devices 301-303 may be embodied as any type of computer and/or storage device comprising firmware, hardware, software, circuitry, and/or combination thereof, that may be configured to perform the functions described herein. Although three such computing devices are shown in FIG. 3, system 10 may have any number of such computing devices. Computing devices 301-303 may contain like assets to that of the illustrative mobile computing device 100 of FIG. 1. Such like assets are not described herein to preserve clarity of the description.

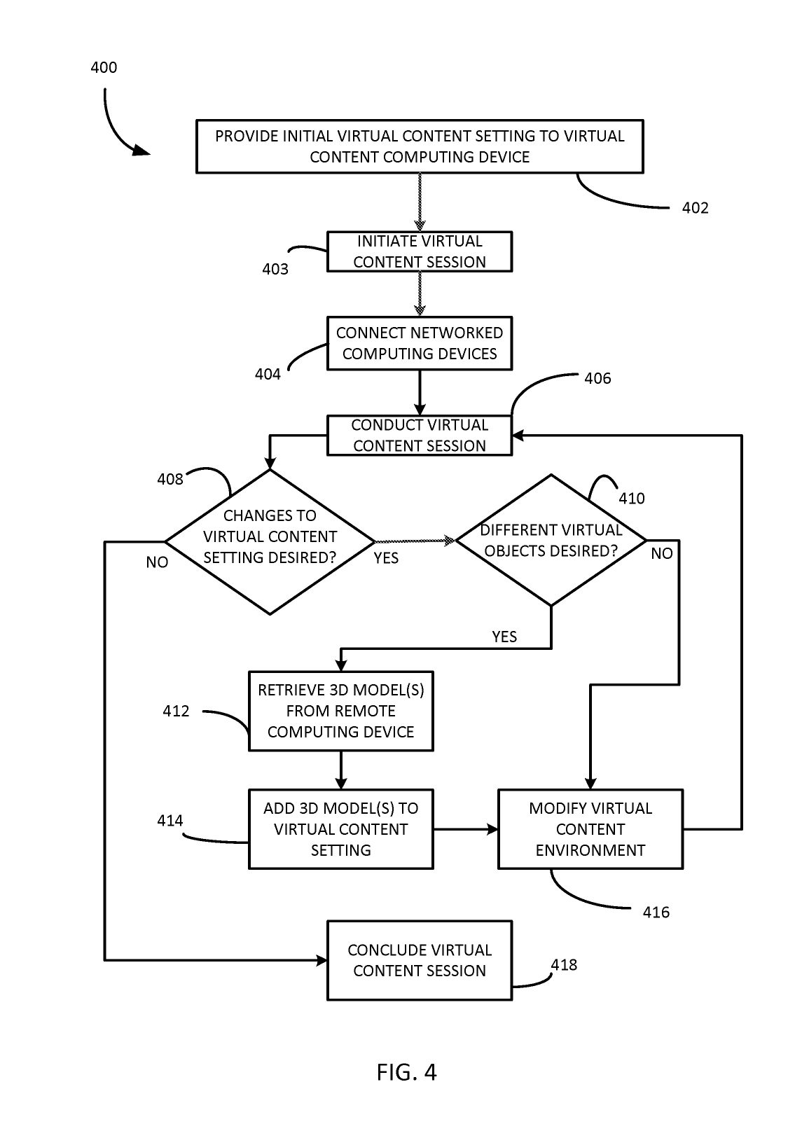

Referring now to FIG. 4, an illustrative method 400 is provided for networked virtual content in a mobile computing environment (that may include one or more non-mobile computing devices). In one or more techniques, perhaps for example prior to the method 400 being invoked, among other scenarios, master resource database 322 may include any number of 3D models of various objects.

The method 400 begins at 402, in which a virtual content setting, comprising a virtual content that may include one or more virtual objects (e.g., 3D models, that may be used within a virtual environment, perhaps in a virtual session), may be provided in digital form to VC computing device 200. At 403, a virtual content session (e.g., perhaps in some devices a virtual reality session) may be initiated on VC computing device 200. At 404, other computing devices, such as, for example, mobile computing device 100, and/or remote computing device 300, and/or other computing devices such as one or more of computing devices 301-303, may be connected to the ongoing virtual content session, such as, for example, via network 216. In one or more techniques of method 400, the virtual content (e.g., virtual reality) setting may be (e.g., simultaneously) visible on at least display 208 of VC computing device 200 and/or display 111 of mobile computing device 100, and/or on one or more, or all, other computing devices that are participating in the virtual content session.

At 408, a user may determine whether changes to the virtual content setting are desired. The user may be a user interfacing with display 208 of VC computing device 200, or may be a user interfacing with display 111 of mobile computing device 100. For example, the virtual content setting may be a living space comprising three dimensional boundaries of a virtual content environment including overhead lighting, doors, windows, flooring, floor coverings, wall colors, and/or the like within the three dimensional boundaries. Also within the three dimensional boundaries of the virtual content environment are one or more virtual objects such as, for example, one or more 3D models of furniture, appliances, floor coverings, and/or the like. If the user determines at 408 that no changes to the virtual content setting are desired, then the method advances at 418 whether the virtual content session may conclude.

Perhaps for example if the user determines that changes to the virtual content setting are desired, then at 410 the user may determine if (e.g., only) changes to the virtual content environment are desired, and/or if one or more virtual objects are desirable to be added and/or subtracted. Perhaps for example if (e.g., only) changes to the virtual content environment are desired, then the method advances to 416 whether the virtual content environment may be modified.

If one or more new/fresh virtual objects may be desired, then at 412-414 the desired virtual objects may be retrieved from remote computing device 200 and/or may be added to the virtual content setting. The user may indicate which 3D model to render and/or a location at which to render the 3D model relative to the virtual content environment. Resource manager 320 may receive a request from VC computing device 200 that may include identifying information of one or more objects that are to be rendered as 3D models in a virtual content setting. Perhaps for example upon receiving the request, among other scenarios, the resource manager 320 may retrieve the one or more 3D models from the local resource database 322 and/or may transmit them to VC computing device 200 via network 216. At 416, the one or more 3D models may be placed in the virtual content environment. At 406, one or more iterations may be performed, perhaps for example until no further changes to the virtual content setting are desired and/or the virtual content session concludes at 418.

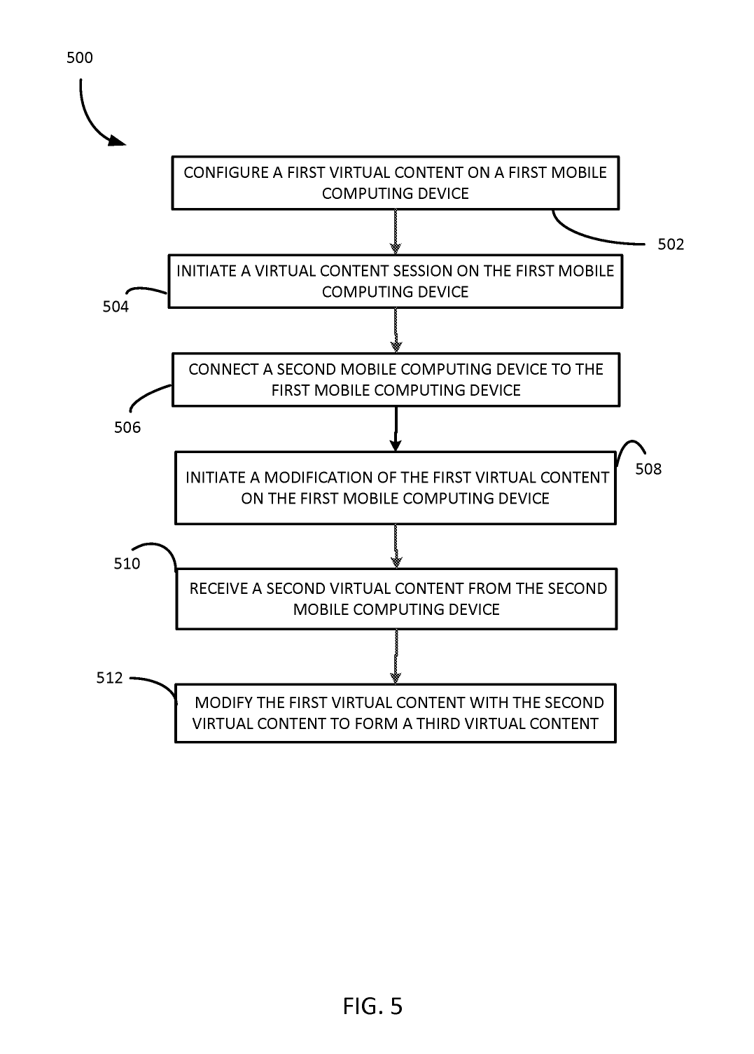

Referring now to FIG. 5, an illustrative method 500 is provided for networked virtual content in a mobile computing environment (that may include one or more non-mobile computing devices). At 502, a first virtual content may be configured on a first mobile computing device. At 504, a virtual content session may be initiated on the first mobile computing device. At 506, a second mobile computing device may be connected to the first mobile computing device. At 508, a modification of the first virtual content may be initiated on the first mobile computing device. At 510, a second virtual content may be received from the second mobile computing device. At 512, the first virtual content may be modified with the second virtual content to form a third virtual content.

System 10 and/or the devices therein may be configured to interface with commerce systems and/or inventory management systems. Many times commerce systems and/or inventory management systems define objects as “models” with “options.” For instance a rug might come in three sizes and/or three colors. In commerce systems and/or inventory management systems, there may be a model ID and/or object ID for the rug itself, then a SKU for one or more, or each, variation of size and/or color. Therefore, the model ID and/or object ID alone might be insufficient to provide the user with a rendering of one or more, or all, options of the object. System 10 and/or the devices therein may be configured to resolve one or more, or all, possible SKU options, and/or to render 3D models of one or more, or each, object using one or more, or each, possible variation. System 10 and/or the devices therein may process 3D model(s), perhaps for example in relation to one or more, or each, of SKU option, and/or may understand the relationship of the model ID and/or object ID to the SKU.

System 10 and/or the devices therein may be configured to use procedural modeling. For example, system 10 and/or the devices therein may be configured for cabinet doors by defining a 2D profile of the door and/or the rules for how to offset door and drawer style profiles from the face of a cabinet. System 10 and/or the devices therein may be configured to dynamically “stretch” the door parameters to fit one door to any cabinet size, perhaps for example instead of modeling one or more, or every, door shape and/or size. For example, system 10 and/or the devices therein can be configured to do this for crown molding, shoe molding, countertops, countertop edge profiles, baseboards, ceiling structures, showers, and/or ceiling lights.

System 10 and/or the devices therein may be configured to render “assemblies,” which are objects mounted on other objects or arranged into some kind of layout. Cabinets in a kitchen, a faucet on a vanity, and/or a lamp on a table may be examples of assemblies. System 10 and/or the devices therein can be configured with the ability to pre-assemble objects into compound objects or assemblies, and/or apply a specific price to the compound object or assembly. System 10 and/or the devices therein can be configured with the ability to mount an object on another object using rules and/or metadata that define fit, location, and/or compatibility. System 10 and/or the devices therein can be configured such that assemblies can also be editable or not editable.

System 10 and/or the devices therein may be configured with business rules for objects and/or assemblies that define what object and/or assembly can physically fit, where the object and/or assembly fits, how object and/or assembly is oriented, and/or whether object and/or assembly can be changed. For example, system 10 and/or the devices therein may be configured with an “object class” concept to define compatibility/fit between objects. For example, a 3-hole faucet fits (e.g., only) on a 3-hole vanity, or a sofa rests on a floor, and/or a dishwasher (e.g., must) be against a wall and/or under a countertop. For example, if a user attempts to place two virtual objects in the same virtual space, system 10 and/or the devices therein may be configured to determine the compatibility/fit between such objects and/or arrange them accordingly.

For example, if a user attempts to place a virtual end table and a virtual lamp in the same virtual location, system 10 and/or the devices therein may be configured to arrange the virtual end table on the floor of the virtual space, and/or the virtual lamp on top of the virtual end table. For example, system 10 and/or the devices therein may be configured to allow for various levels of specificity to determine fit. Sometimes there may be (e.g., only) one specific object that can fit on another specific object. Other times there may be a larger set of objects that can fit together. In addition to physical compatibility, for example, system 10 and/or the devices therein may be configured to allow for merchandising rules that allow the content managers to say which categories or other object attributes are allowed to fit in a location. For instance, system 10 and/or the devices therein may be configured to such that the user can put any 3-hole faucet on this 3-hole vanity (using object class), but perhaps for example (e.g., only) Kohler® faucets are allowed if the users want a specific price over a Labor Day Sale (using object manufacturer).

System 10 and/or the devices therein may be configured with composition properties that may define how an object can be composed in a scene. For example, regarding refrigerators, system 10 and/or the devices therein may be configured to require that refrigerators have to be mounted on a floor and/or against a wall, that the refrigerators cannot be rotated, and/or that refrigerator doors can be rotated, but (e.g., only) about a specific anchoring point and within a specific arc.

System 10 and/or the devices therein may be configured with composition properties that may allow animations of objects for manipulating object parts, for example usually to show the inside and/or some range of motion. For example regarding refrigerators, system 10 and/or the devices therein may be configured to allow animation to be data-driven and/or assigned for a class of objects vs. assigned to each specific 3D model. System 10 and/or the devices therein can be configured to allow objects to make sounds, and/or for lighting (e.g., lights, lamps, ceiling fans) to have properties that allow control of angle, spread, and/or intensity. Augmented reality blends a user's environment with digital information (e.g., virtual objects), generally in real time. In other words, the digital information is embedded, or overlays, the actual environment. Typically, image recognition software analyzes environment information as detected from one or more images of the environment, as well as a location of the mobile computing device that captured the image relative to the environment at the time at which the respective images were taken, and renders realistic virtual objects in the environment. Because it can be difficult to anticipate the movement of the mobile computing device relative to the environment in advance, the virtual objects may be rendered in real-time. In one or more techniques, systems, devices, and/or methods disclosed herein may be adapted for augmented reality.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

What is claimed is:

1. A method for composing a virtual content in a first mobile computing device, the method comprising:
configuring a first virtual content on the first mobile computing device;
initiating a virtual content session on the first mobile computing device;
connecting at least a second mobile computing device to the first mobile computing device;
initiating a modification of the first virtual content on the first mobile computing device;
receiving a second virtual content from the second mobile computing device as part of the modification of the first virtual content;
modifying the first virtual content with at least the second virtual content to form a third virtual content; and
rendering the third virtual content in the virtual content session on a display of the first mobile computing device.

2. The method of claim 1, wherein the first mobile computing device is a virtual reality computing device, and the method further comprises:
initiating a virtual reality session on the first mobile computing device; and
rendering the third virtual content in the virtual reality session on the first mobile computing device.

3. The method of claim 1, wherein the configuring the first virtual content on the first mobile computing device comprises:
receiving the first virtual content from the second mobile computing device; and
rendering the first virtual content in the virtual content session on the display of the first mobile computing device.

4. The method of claim 1, wherein the configuring the first virtual content on the first mobile computing device comprises:
selecting at least one virtual item for addition to the first virtual content; and
rendering the first virtual content in the virtual content session on the display of the first mobile computing device.

5. The method of claim 4, wherein the configuring the first virtual content on the first mobile computing device further comprises:
determining information regarding at least one of: a fit, a location, or a compatibility of the at least one virtual item relative to the first virtual content; and
adding the at least one virtual item to the first virtual content based, at least in part, in the information, wherein the first virtual item is at least one of: a virtual object, or a virtual assembly.

6. The method of claim 1, wherein the first virtual content includes at least one of: a virtual object, or a virtual assembly.

7. The method of claim 1, wherein the modifying the first virtual content with at least the second virtual content to form the third virtual content is a synchronizing of the first virtual content with a virtual content of the second mobile computing device.

8. The method of claim 1, wherein the third virtual content is simultaneously rendered in a virtual content session on a display of the second mobile computing device.

9. The method of claim 1, further comprising:
initiating a modification of the third virtual content on the first mobile computing device;
receiving a fourth virtual content from the second mobile computing device as part of the modification of the third virtual content;
modifying the third virtual content with at least the fourth virtual content to form a fifth virtual content; and
rendering the fifth virtual content in the virtual content session on the display of the first mobile computing device.

10. The method of claim 1, further comprising:
connecting at least a third non-mobile computing device to the first mobile computing device;
initiating a modification of the third virtual content on the first mobile computing device;
receiving a fourth virtual content from the third non-mobile computing device as part of the modification of the third virtual content;
modifying the third virtual content with at least the fourth virtual content to form a fifth virtual content; and
rendering the fifth virtual content in the virtual content session on the display of the first mobile computing device.

11. The method of claim 10, wherein the modifying the third virtual content with at least the fourth virtual content to form the fifth virtual content is a synchronizing of the third virtual content with a virtual content of the third non-mobile computing device.

12. The method of claim 10, wherein the fifth virtual content is simultaneously rendered in a virtual content session on a display of the third non-mobile computing device.

13. A first mobile computing device configured to compose a virtual content, the first mobile computing device comprising:
a memory;
a display; and
a processor, the processor configured at least to:
configure a first virtual content;
initiate a virtual content session;
connect to at least a second mobile computing device;
initiate a modification of the first virtual content;
receive a second virtual content from the second mobile computing device as part of the modification of the first virtual content;
modify the first virtual content with at least the second virtual content to form a third virtual content; and
render the third virtual content in the virtual content session on the display.

14. The device of claim 13, wherein the first mobile computing device is a virtual reality computing device, and the processor is further configured to:
initiate a virtual reality session; and
render the third virtual content in the virtual reality session.

15. The device of claim 13, wherein to configure the first virtual content the processor is further configured to:
receive the first virtual content from the second mobile computing device; and
render the first virtual content in the virtual content session on the display.

16. The device of claim 13, wherein to configure the first virtual content the processor is further configured to:
select at least one virtual item for addition to the first virtual content;
render the first virtual content in the virtual content session on the display;
determine information regarding at least one of: a fit, a location, or a compatibility of the at least one virtual item relative to the first virtual content; and
add the at least one virtual item to the first virtual content based, at least in part, in the information, wherein the first virtual item is at least one of: a virtual object, or a virtual assembly.

17. The device of claim 13, wherein the modification of the first virtual content with at least the second virtual content to form the third virtual content is a synchronization of the first virtual content with a virtual content of the second mobile computing device.

18. The device of claim 13, wherein the third virtual content is simultaneously rendered in a virtual content session on a display of the second mobile computing device.

19. The device of claim 13, wherein the processor is further configured to:
connect to at least a third non-mobile computing device;
initiate a modification of the third virtual content on the first mobile computing device;
receive a fourth virtual content from the third non-mobile computing device as part of the modification of the third virtual content;
modify the third virtual content with at least the fourth virtual content to form a fifth virtual content; and
render the fifth virtual content in the virtual content session on the display.

20. The device of claim 19, wherein the modification of the third virtual content with at least the fourth virtual content to form the fifth virtual content is a synchronization of the third virtual content with a virtual content of the third non-mobile computing device.
